(19) United States
(12) Patent Application Publication
(10) Pub. No.: US 2021/0079250 A1
(43) Pub. Date: Mar. 18, 2021

(54) SUPERFICIALLY COATED VEGETABLE FIBERS, PROCESS FOR THEIR PRODUCTION, AND USE THEREOF IN THE PRODUCTION OF MANUFACTURED ARTICLES

(71) Applicants: Marco CIOLI, Desenzano Del Garda (IT); Vittorio DE GASPERINI, Desenzano Del Garda (IT); Giuseppe TAVELLI, Castel Mella (IT)

(72) Inventors: Marco CIOLI, Desenzano Del Garda (IT); Vittorio DE GASPERINI, Desenzano Del Garda (IT); Giuseppe TAVELLI, Castel Mella (IT)

(21) Appl. No.: 16/612,197

(22) PCT Filed: May 7, 2018
(86) PCT No.: PCT/EP2018/061692

§ 371 Date: Nov. 8, 2019

(30) Foreign Application Priority Data
May 8, 2017 (IT) 102017000049506

(51) Int. Cl. C09D 103/02; C08L 97/02

(52) U.S. Cl. CPC C09D 103/02; C08L 97/02

(57) ABSTRACT

A process is described for coating the surface of a particulate of natural fibers, such that the resulting fibers can be compacted to form manufactured articles at pressures of an order of magnitude lower than the pressure values currently used for this purpose and at reduced temperatures, or may be incorporated into composites with polymeric materials without the need of using compatibilizing compounds or treatments.

### FIELD OF THE INVENTION

The present invention refers to a particulate of vegetable fibers, in particular of woody type, superficially coated with a composition which modifies the properties of mutual adhesion as well as their compatibility with polymeric materials; the invention also relates to the process for obtaining the particulate of coated fibers; finally, the invention relates to manufactured articles obtained by compacting the particulate of coated vegetable fibers alone, or else by consolidation through the addition of polymers to the particulate itself.

### STATE OF THE ART

In agricultural and industrial activities are produced large quantities of residues and waste materials that can be gathered under the general definition of woody materials; these materials are basically composed by cellulose and lignin in variable ratios, further to other components that depend of the specific material type.

Among the woody materials one can mention, just to give some examples, wood chips, sawdust, wood flour, barks, straw, miscanthus, pruning residues, but also others residues of plant origin (nut shells, beet pulp, etc.), chopped or ground through mechanical methods.

There is therefore a need to dispose of these wastes, preferably allocating them to some form of reuse and/or recycle.

Woody material in particulate form is also intentionally produced, not just from waste material, for example for the production of particle boards.

A first application in which woody particulate (in particular from waste material) is used is pelletizing, in which small cylinders of compact material (“pellets”) are formed, that are used to feed suitable burners.

Another application is the production of a wide range of composite materials that are commonly indicated with the acronym WPC (“Wood and Polymer Composite”), in which the woody particulate is compacted by means of organic materials, which can be glues or actual polymeric matrices.

In the field of WPCs, depending on the type and amount of organic material, there are different products.

A first type of use is the production of boards obtained from woody particulate by gluing with thermosetting resins. In these products, the woody material is generally used in the form of flakes and/or granules, of thicknesses generally lower than one millimeter and side size up to a few centimeters; as resins, for example, those based on urea formaldehyde or phenol formaldehyde, epoxy resins, polyester resins, urethane, etc. are used.

These boards are made by mixing the woody particulate with the minimum indispensable amount of monomer(s) and polymerization catalyst, generally comprised between about 10 and 17% by weight of the final product, and then solidifying the mix. The polymer is always of cross-linked type, and the resulting product has no elastic or thermoformable characteristics. In this way, boards of material known as “chipboard” are obtained, having a thickness from about half a centimeter to a few centimeters, used in building and as a structural material in the furniture industry; in this last case the material is generally not visible and is covered with thin layers of wood (veneer) or with polymer laminates or papers (ennobling).

In a second type of WPC materials, there are used woody particulates with a lower particle size, from a few millimeters up to the wood flour, and higher polymer contents, for example with ratios between the polymer and the woody component between 9:1 and 1:1, typically around 3:2. This type of WPC is produced from particulates of a few selected types of wood only, because the properties of the final product vary considerably with the type of wood and the industrial production has been standardized on the production conditions of a restricted range of wood types; for example, the broad-leaved wood is preferred when the resins of coniferous woods interfere with the compatibilization process and the latter are therefore considered less performing. These composites have an esthetically appreciated appearance, and are generally used to produce manufactured articles having a decorative purpose, for example in the manufacture of inner components of cars of numerous car manufacturers, or else in the production of shaped articles for home indoor and above all outdoor furniture (thanks to the resistance to atmospheric agents conferred by the polymeric component).

All these productions present today critical elements. Pellets and briquettes for burners are produced with a process, adopted by all manufacturers, that requires temperatures normally between 90 and 120° C., but that can also reach 220° C., and above all very high pressures, in the order of 1500-4500 bar; in this regard, see for instance the paper “Importance of temperature, moisture content, and species for the conversion process of wood residues into fuel pellet”; N. P. K. Nielsen et al., Wood and Fiber Science (2009), Vol. 41 No. 4, pp. 414-425.

In this process the use of additives is admitted in a maximum amount of 2% by weight of the final product, and they are generally graminaceous flour or vegetable oils added as such, while synthetic products such as glues (polyvinyl acetates, polyvinyl alcohols, etc., as well as chemically reacting adhesives, urethane glues, etc.), are absolutely excluded. The mechanism by which the particles of the woody wastes adhere upon compaction is not fully understood; according to a current theory, the treatment under the indicated conditions leads to the melting of the lignin matrix of the material, which then re-solidifies in amorphous form at the output of the pelletizing plant, forming a new matrix that keeps the lignocellulosic fibers adherent. This theory however has not been verified and does not seem entirely convincing. What matters, anyway, is that the pelletizing treatment described above is an extremely energy-intensive technique that requires massive and expensive plants (above all to withstand the extremely high pressures used); besides, the technology is mature, and perhaps also due to the lack of knowledge of the underlying mechanisms, there are no foreseeable improvements in the process that could make it less burdensome.

In the production of WPC (both with low and high content of polymer fraction), synthetic glues or polymers are added to the wood waste. Since glues and polymers may have non-polar and hydrophobic characteristics, while hemicellulose and cellulose are polar and hydrophilic materials (due to the presence of numerous hydroxyl groups on their surface), the mutual affinity of the two materials is poor and adhesion is only little effective. For the formation of these composites it is therefore necessary the addition to the mixture of compatibilizer compounds, such as acetic anhydride, methylisocyanate, or else polymeric compounds such as polypropylene maleate (MAPP), styrene-ethylene/butylene-styrene maleate (SEBS-MA), styrene-maleic anhydride (SMA) or polyethylene grafted with maleic anhydride (MAPE); for further information about compatibilizers and their methods of use see for example the article “Chemical coupling in wood fiber and polymer composites; a review of coupling agents and treatments”, J. Z. Lu et al., Wood and Fiber Science, 200, 32 (1), pagg. 88-104.

These compatibilizers add cost to the final product, and may pose problems during the production of the composite, due for instance to the release of aggressive and irritating vapors, as in the case of acetic anhydride or even of MAPE, which despite appearing as a solid has an acrid smell; furthermore, even in known processes of WPC production, it is necessary to reach temperatures well above 100° C., and generally between about 130 and 220° C. (see Table 2 in the aforementioned article of J. Z. Lu et al.), which consume energy and worsen the problems related to the release of irritating vapors, requiring the adoption of appropriate suction systems.

These compatibilizing techniques may produce covalent bonds between the fibers and added compounds, altering the nature and the chemical structure of the vegetable fibers. These changes have direct effects on the biocompatibility and biodegradation of the obtained products, as well as on the possibility of re-using the product material at the end of its life.

The possibility of using products of natural origin as glues for woody materials has also been studied. Patent applications EP 1327663 A1 and WO 2007/062265 A2, both in the name of New Ice Ltd. and of almost identical contents, describe compositions containing woody particulate, wood flour or paper pulp, and a starch gel as a glue. These compositions are prepared starting from a mixture of one or more starches in the form of a gel in water to which the cellulosic material (wood or paper) is added, along with other possible components such as glycerol, waxes, clays or inorganic compounds; in wet form, these compositions contain between 11 and 37% by weight of cellulosic material (EP 1327663 A1, paragraph [0061]) and preferably between 11 and 23.3% by weight of cellulosic material (EP 1327663 A1, paragraphs [0052] and [0084]), and high amounts of water, which can vary between about 45 and 72% by weight of the overall wet composition. Once a paste is formed with the wet compositions, these are formed or molded and then dried with heat treatments at temperatures between about 195 and 225° C. and times between 60 and 90 seconds; in these treatments the water is partially lost and/or eliminated, and the final compositions result partially or total anhydrous. A recalculation of the amounts of components in the final dry compositions (thus excluding the water component) indicates that the starch content is not less than 30%, and that it can reach values of almost 80% by weight, while the content of cellulosic material is between 20 and 60% by weight. The purpose of these documents is mainly to produce manufactured articles (in particular food containers) made only with natural materials; as the main purpose of these documents is not the recycling of woody materials, the efficiency of use or recycling of woody material is low, as is also evident from the high value of the starch/wood weight ratio in all the examples of these documents, and that it is often higher than 1.

It is an object of the present invention to provide a particulate of superficially coated vegetable fibers having a high mutual adhesion of the particulate particles and a high compatibility of these with polymeric materials, thus allowing to avoid the use of the very high pressures in the case of the production of pellets and briquettes as well as of chemically aggressive or harmful compatibilizers in the case of WPC composites.

Another object of the present invention is to provide a compatibilization technique, which does not involve any chemical modification on the vegetable fibers and keeps therefore the original nature of the same unaltered, even after the addition of an artificial polymer matrix.

Another object of the invention is to provide a process for producing the particulate of coated vegetable fibers.

### SUMMARY OF THE INVENTION

These objects are achieved with the present invention, that in a first aspect refers to a method for superficially coating a particulate of vegetable fibers, such that the thus coated particles present high mutual adhesion characteristics and compatibility with polymers. This method comprises the steps of:
a) preparing a modified starch gel comprising water, a starch, and a salt of a divalent metal selected among alkaline-earth metals, metals of the first transition series and tin, in which the salt is in quantity from 0.5 to 20% by weight with respect to starch;
b) mixing the starch gel thus obtained with a woody particulate in a weight ratio such that the resulting mixture contains between 85 and 99% by weight of woody particulate with respect to the sum of weights of the dry components only of the composition.

In a second aspect thereof the invention refers to the woody particulate coated with the modified starch gel obtained according to the first aspect of the invention.

Finally, in a third aspect thereof, the invention refers to the articles obtained by compaction of the woody particulate coated with modified starch gel or else to the formation of a composite between the coated particulate and a polymeric material.

### BRIEF DESCRIPTION OF THE FIGURES

FIG. 1 shows a section view of a mold used to make samples to be submitted to breaking load tests;

FIG. 2 shows the equipment to determine the breaking load of manufactured articles of pellet type.

### DETAILED DESCRIPTION OF THE INVENTION

In the following description and in the claims, the gelatinized starch containing a salt of a divalent metal produced and used in the invention is referred to as “modified starch gel”, or simply “modified gel”. Moreover, in the text and in the claims, all weight ratios and weight percentages are to be intended “dry on dry”, namely referring to the weight of the dry particulate, of the dry starch and of the dry salts, unless specified otherwise.

In its first aspect, the invention relates to a method for superficially coating a particulate of vegetable fibers, which comprises the steps of:
a) preparing a modified starch gel comprising water, a starch, and a salt of a divalent metal selected among alkaline-earth metals, metals of the first transition series and tin, in which the salt is in quantity from 0.5 to 20% by weight with respect to starch;
b) mixing the starch gel thus obtained with a woody particulate in a weight ratio such that the resulting mixture contains between 85 and 99% by weight of woody particulate with respect to the sum of weights of the dry components only of the composition.

Starch gel is a well-known product, used mainly in the field of chemical analysis. This gel is obtained starting from starch, initially wetting it with a small amount of cool water (for example, about 1-2 mL of water per gram of starch), pouring the wet starch in hot water (for instance 8 mL of water at 35° C. per gram of starch), bringing the mix under stirring to a gelling temperature for a few minutes (the starch granules swell adsorbing water and the dispersion turns into a colloidal fluid gel), and finally letting the system to cool, obtaining a solid gel. The gelling temperature varies with the type of starch, and is generally between 65 and 80° C.

The addition of starch gel as adhesive for cellulose-based particulate material is widely used mainly in the paper industry, but if further to cellulose a lignin matrix is present (as it is in the integral lignocellulose fibers), the adhesive effect declines in a few hours or, in the best cases, in a few days. It is known indeed that a starch gel obtained from starch alone undergoes the so-called “retrogradation” phenomenon, which consists in the recrystallization and depolymerization of the starch present in the gel, and that this phenomenon occurs at the expense of the adhesive process. This phenomenon takes place within a few days after preparation of the gel, and the gel loses its adhesive properties for the woody particulate as a consequence; the manufactured articles obtained in the past by compaction of woody particulate with starch gel became brittle and were prone to crumbling in a short time.

The inventors have instead observed that by using a modified starch gel, as described below, the manufactured articles remain compact and indefinitely maintain their mechanical properties unaltered.

Step a) of the process of the invention consists in the preparation of a starch gel modified trough the addition of a salt of a divalent metal selected among alkaline earth metals, metals of the first transition series, and tin.

The preferred salts for the preparation of the modified gel of the invention are those of calcium and magnesium; more preferably, the salt to be used is selected among calcium carbonate (CaCO₃), calcium oxalate (CaC₂O₄), calcium phosphate (Ca₃(PO₄)₂) and magnesium carbonate (MgCO₃).

The modified gel can be prepared according to two alternative methods, the first consisting of the preparation of a normal starch gel and subsequent incorporation of the salt, and the second consisting in the preparation of the gel starting from a mixture of starch and salt.

These two methods employ the same quantities of components and they give essentially the same results.

The first method is based on observation that a starch gel, prepared according to the known methodology, is able to dissolve (or homogeneously disperse) the divalent metal salts, normally slightly soluble in water; in order to promote the dissolution of the salt, it is possible to warm the previously prepared gel while keeping it under vigorous stirring, and keeping the system under stirring until the solid disappears.

In the second method, the metal salt, preferably in finely divided form, is added initially to the starch, and the preparation process of the gel is carried out on this mixture; the inventors have observed that it is not necessary in this case to go through the usual two-steps procedure (addition of cold water first and of hot water later on), and that the modified gel can be produced simply by adding water to the mixture of powders, heating it until a gel is formed, and keeping the system under stirring until a solution with homogeneous appearance is obtained, which is normally obtained almost immediately upon reaching the gelation temperature.

The modified gel of the invention is prepared with a starch amount of between 10 and 50 g per 100 mL of water.

The salt of the divalent metal is employed in amounts from 0.5 to 20% by weight with respect to the dry weight of the starch, preferably between 1 and 15%, and even more preferably of about 7-8%.

Step b) of the process consists in distributing the gel on the surface of the woody particulate, in an amount by weight such that the resulting mixture contains an amount of between 85 and 99%, preferably between 90 and 98%, and more preferably between 96 and 98% by weight of woody particulate (percentages evaluated considering the weights of dry woody particulate, dry starch and dry divalent metal salt only).

The amount of modified gel with respect to particulate depends on the apparent surface of the woody particulate itself (that is, the geometric surface, disregarding the contribution of the specific surface due to the porosity of the material), and the optimal amount can be tailored according to the type of particulate, remaining in the aforementioned ranges, with a few indicative tests; for example, the inventors have observed that when using as woody particulate granules selected through a 5 mm sieve/grid (as in the classic shredding and selecting procedure of hammer mill, from which particles of axial size from a fraction of millimeter to a few millimeters, and maximum radial size 5 millimeters), the optimal amount of modified gel is such that the total weight of starch and divalent metal salt (measured dry) is between about 1.5 and 4% by weight of the total mixture.

In order to obtain an effective dispersion of the modified gel on the particles surface, the mixture obtained after joining the components is mixed or stirred with mechanical means for times ranging from a few seconds to a few minutes; longer treatment times increase the process costs without leading to further improvement in material characteristics. It has been observed that mechanical mixing of modified gel with particulate takes place without producing material lumps; the particles do not adhere to each other during the mixing process, which can therefore proceed for longer or shorter times without the occurrence of pre-agglomeration phenomena. The adhesive effects are evident only after compression of the particulate. The thus obtained woody particulate coated with modified gel maintains the characteristic of adhesiveness even if used after many hours and in some cases even after many days, even in case of partial or natural dehydration, especially if the compression occurs at temperatures higher than ambient temperature (for example, 50° C.) and possibly prolonging the compression operation for a few seconds (for example, 15 s).

Finally, in its third aspect, the invention relates to manufactured articles obtained by compaction of woody particulate coated with modified starch gel, or by forming a composite of said coated particulate with a polymeric material.

The manufactured articles formed by compaction of the coated particulate alone can be produced subjecting the particulate to compression, for example in a mold, applying a pressure between 170 and 280 bar and operating at a temperature lower than 100° C.

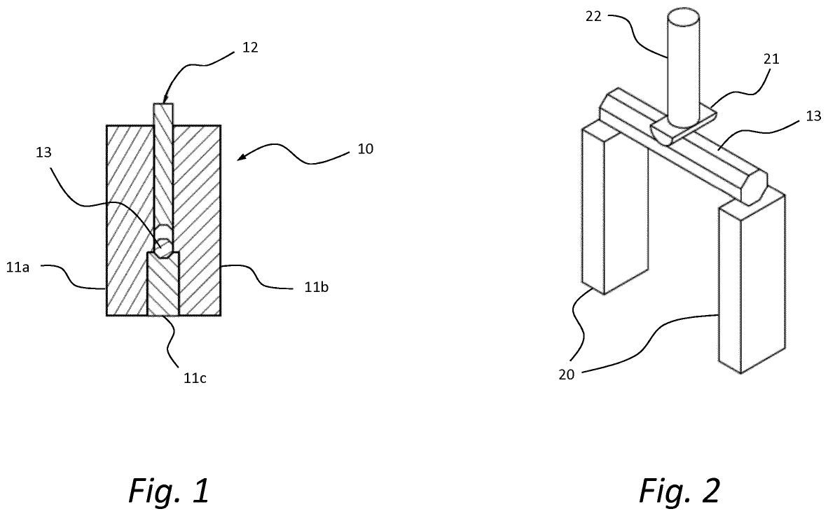

As is evident, the shape of the mold corresponds to that of the manufactured article to be produced, and can therefore have highly variable conformations; also the production of the molds, once the desired shape has been defined, is quite obvious for a skilled person in the field. By way of example, FIG. 1 shows (in section) the mold that was used for the production of specimens used in the breaking load tests described in the examples that follow. This mold is designed for the production of specimens in the form of bars with an octagonal section, and consists of two side walls 11a and 11b and a base 11c fixed to each other; walls 11a and 11b are parallel to each other and have a distance corresponding to the section of the specimen; between walls 11a and 11b a slider 12 is inserted, having a thickness corresponding to the distance between 11a and 11b; by inserting a desired amount of particulate into the bottom of the mold formed by parts 11a, 11b and 11c, applying pressure to the slider 12, and heating the mold walls (with temperature and pressure values as detailed below), the compaction of the particulate is obtained forming a specimen 13.

Compression can be carried out at room temperature (lower temperatures, obtained by forced cooling, negatively affect the results); however, it has been observed that the best results are obtained at temperatures higher than the ambient temperature, preferably between 40 and 70° C.

The pressure required for this process operation is between 170 and 280 bar, and preferably between 220 and 250 bar. The inventors have observed that working with pressure values above 280 bar leads to products which show defects and have poor mechanical resistance. This last observation in particular is surprising, and makes it possible to clearly distinguish the process of the invention from the densification and pelletizing processes of the prior art, which employ pressures of about one order of magnitude higher.

Immediately after forming, the manufactured articles of the invention have a moisture content higher than that of the starting particulate, equal to the quantity of water supplied by the gel; later on, with a natural process of dehydration that also occurs at room temperature, the moisture content returns very close to the value of the original particulate. This phenomenon occurs in 48 hours at a temperature of 30° C., and at the end the products are considered stabilized.

The manufactured articles obtained through the process of the invention have density values ranging from 0.8 to 1.2 g/mL, and high fracture resistance. Breaking load tests performed on samples made with and without treatment with the modified gel of the invention indicate that the treated samples have a load resistance 100 times higher. Furthermore, the samples of the invention have a resistance even higher than that of the pellets obtained with the current method which requires compression at 1500-2000 bar, as shown in the following examples. Furthermore, these articles show a low release of particles or dust upon fracture or rupture.

The woody particulate coated with modified gel, object of the second aspect of the invention, has also proved to be compatible with polymeric materials, and is therefore suitable for incorporation into WPC composites, without requiring the use of the irritant or harmful compatibilizers of the known art. The most commonly used polymers in this production are, for example, low or high density polyethylene (LDPE and HDPE, respectively), polypropylene (PP) or polyvinylchloride (PVC), but the technique lends itself be employed with any polymer.

WPC composites can be produced with the wood particulate coated with modified gel either by dispersing the particulate on previously produced polymer-made parts (for example, polymer sheets) and bringing the polymer to its melting T, or by producing the composite directly from a mixture made of the molten polymer charged with particulate matter (for example, by extrusion or molding). In the case of production starting from a mixture of melted polymer and coated particulate, expansion and swelling agents can be added to the polymer which allow to further control the density and characteristics of the final product.

The inventors have noted that WPC articles produced with the particulate of the invention exhibit a considerable intergranular porosity (fine holes, probably created by the presence of vapor bubbles during the compressing and melting process). This characteristic is however particularly interesting, as it offers the possibility of performing post-processing on the manufactured articles by impregnating them with liquid polymer resins, which allows to control and modulate the technical and aesthetic properties of the final product. In fact, having a polymer matrix accessible throughout its volume from the surface, it is possible to operate in post-production not only on the outer surfaces of the manufactured article. With this technique it is possible to make products containing long fibers, such as those of agave or kenaf, in which these vegetal fibers can be considered substitutes for glass fibers (or synthetic fibers in general).

Another advantage of the invention is that it allows the use of a wider range of types and qualities of woods and/or alternative vegetal materials such as barks, straw, etc.

The invention will be further described in the following experimental part.

### EXAMPLE 1

This example refers to the preparation of a modified starch gel according to the first aspect of the invention.

500 g of water were added to 100 g of MAIZENA starch (100% maize starch produced by Unilever Food Solutions) and 10 g of CaCO₃ (Sigma-Aldrich, product code 795445, purity>99.0%). The mixture was heated to 75° C. and kept at this temperature for 3 minutes under stirring, and thereafter allowed to cool to room temperature. This modified starch gel contains, by weight, about 82% of water and 18% of dry components (starch+CaCO₃).

The modified starch gel thus obtained was used in the following examples.

### EXAMPLE 2

This example refers to the preparation of a vegetal particulate coated with the modified starch gel obtained in Example 1.

100 g of woody granulate were prepared, made up of coniferous wood particles passed through a 5 mm sieve. To this granulate, 35 g of modified gel of Example 1 were added, corresponding to an addition of about 6.3 g of dry matter (starch/CaCO₃ mixture) and 28.7 g of water; the woody granulate corresponds to about 94% by weight of the dry fraction (i.e., disregarding the water) of the obtained mixture.

The mixture thus obtained was kept under mechanical stirring at 60 Hertz for 5 minutes (300 revolutions) in a 25 cm diameter batch.

The resulting material constitutes Sample 1.

### EXAMPLE 3

This example refers to the preparation of an article obtained by simple compaction of vegetal particulate by compression.

1.5 g of Sample 1 were introduced into the mold of FIG. 1 and compressed at 200 bar for 2 seconds with the mold maintained at a temperature of 60° C.; after having extracted it from the mold, the sample was kept at 30° C. for 48 hours to allow moisture to evaporate (stabilization). The resulting specimen, a bar having octagonal section of a width of 6 mm and a length of 32 mm, constitutes Sample 2.

### EXAMPLE 4

This example refers to breaking load measurements of pellets made according to the method of the invention and, for comparison, of pellets made following the traditional method.

Sample 2 was subjected to a breaking load test, using the apparatus shown in FIG. 2. The apparatus consists of two supports 20 of the sample to be tested (item 13 in the figure), spaced 18 mm from each other; the sample is suspended on the gap formed by the two supports 20, and at the center of the sample an increasing load is applied with a punch 21, until the sample breaks; the punch is shown in the figure with a semi-cylindrical section, but it may have any section which concentrates the load along a line transverse to the sample. The element that applies the load is shown in the figure as a general element 22; this can be a part of an apparatus that applies a continuously increasing load, or a discrete element of known weight. In the test, Sample 2 was ruptured at an applied load of 7 kg.

For comparison, a sample of the same size, formed from the same woody material, obtained however in this case by the method of the prior art (extrusion at 1500 bar and 100° C.) was subjected to the same type of measurement; this sample underwent breaking at an applied load of about 0.7 kg.

A similar test was carried out also on a sample produced according to the invention immediately after forming, without waiting for stabilization; this test yielded a slightly lower result than that obtained with Sample 2, showing a breaking load value of 5 kg compared to 7 kg of the stabilized pellet, a value however also in this case much better than the with the pellet obtained by traditional way.

### EXAMPLE 5

This example refers to the preparation of a manufactured article obtained with a particulate treated with the modified gel of the invention and a polymeric material (sheets of polyethylene, PE).

To a woody particulate, stabilized in an atmosphere at 60% relative humidity at room temperature (which leads to a moisture content of 12-15%), 4.5% by weight of modified starch of Example 1 was added, which brings the moisture content to a value of around 30-35%.

The so obtained particulate was sieved to recover two particle-size fractions, respectively called fraction A and fraction B. Fraction A is the one obtained starting from the initial particulate and passing through a sieve with openings of 0.5 mm; fraction B was obtained by sifting the particulate remaining after separation of fraction A, and passing through a sieve with openings of 7 mm. 35 g of fraction A and 65 g of fraction B were obtained.

In a mold having dimensions 150×70 mm were arranged in succession:
1—a sheet of size 150×70 mm of aluminum film greased with vaseline oil (detacher from the mold), to be discarded after extraction of the final product;
2—a sheet of LDPE of size 150×70 mm weighing 0.6 g;
3—2.2 g of particulate of fraction A were uniformly dispersed onto the surface of the LDPE sheet;
4—steps (2) and (3) were repeated seven times, and afterwards only operation (2) was repeated once, for a total of 5.4 g of LDPE and 17.6 g of particulate matter;
5—onto the last sheet of LDPE, 3.3 g of particulate of fraction B were uniformly dispersed;
6—steps (2) and (5) were repeated nineteen times (for a total of 11.4 g of LDPE and 66 g of particulate);
7—steps (2) and (3) were repeated eight times (for a total of 4.8 g of LDPE and 17.6 g of particulate);
8—step (2) was repeated once;
9—finally, step (1) was repeated, overlapping an aluminum sheet greased with vaseline oil on the last sheet of LDPE.

In this way a multilayer, referred to in the field as “mattress”, was obtained, comprising 22.2 g of polymer and 100 g of vegetal particulate.

The thus obtained mattress was gradually compressed up to 70 bar and heated. When the mattress reached the temperature of 110° C., the pressure was released causing the excess steam to discharge; then compression was resumed by heating up to 130° C., pressure was released again to allow the discharge of the produced steam, and the mattress was compressed again to 70 bar.

Finally, the system was allowed to cool to a temperature of just below 110° C. and the article was freed.

A tile of size 150×70×15 mm with a weight of 122 g was obtained, which corresponds to an average density of 0.775 g/cm³. The polymer is present at 18% by weight on the total weight of the tile.

From this tile three square samples of 5 cm of side were cut; the three samples were immersed in water for 24 hours at temperature 20° C., then extracted from water and dried with absorbent paper. The thickness of the samples after immersion in water was measured, and an average linear dilatation (in the thickness direction) of 6.2% was detected.

The woody particulate treated with the modified starch gel according to the present invention unexpectedly shows an excellent affinity with the thermoplastic polymeric material, and can therefore be used for the production of WPC-type products without having to resort to the use of potentially toxic synthetic compatibilizers.

1. A process for superficially coating particles of vegetable fibers to make them mutually adherent and compatible with organic polymers, which includes the steps of:
a) preparing a modified starch gel comprising water, a starch, and a salt of a divalent metal selected among the alkaline-earth metals, metals of the first transition series and tin, in which the gel is prepared with a starch amount of between 10 and 50 gr per 100 mL of water and the salt is in a quantity of 0.5 at 20% by weight with respect to starch;
b) mixing the starch gel thus obtained to the woody particulate in a weight ratio such that the resulting mixture contains between 85 and 99% by weight of woody particulate with respect to the sum of weights of the dry components only of the composition.

2. The process according to claim 1, wherein in step a) a starch amount of between 15 and 40 g per 100 mL of water is used.

3. The process according to claim 1, in which in step a) the salt of the divalent metal is used in an amount from 1 to 15% by weight with respect to the starch.

4. The process according to claim 3, wherein the salt of the divalent metal is used in amount from 7 to 8% by weight with respect to the starch.

5. The process according to claim 1, in which the salt of the divalent metal used in step a) is selected among calcium carbonate (CaCO₃), calcium oxalate (CaC₂O₄), calcium phosphate (Ca₃(PO₄)₂) and magnesium carbonate (MgCO₃).

6. The process according to claim 1, in which step a) is carried out by initially preparing a gel with only starch, and subsequently dissolving in the gel one of said divalent metal salts.

7. The process according to claim 6, wherein the dissolution of said salt is obtained by heating the gel previously prepared at a temperature lower than that of gelling, and keeping the system under stirring until the solid disappears.

8. The process according to claim 1, in which step a) is carried out by adding hot water to a mixture of starch and powders of the divalent metal salt and maintaining the system under stirring until a solution of homogeneous appearance is obtained.

9. The process according to claim 1, in which step b) is carried out by mixing the modified starch gel obtained in step a) to the woody particulate in a weight ratio such that the resulting mixture contains an amount of woody particulate between 90 and 98% by weight with respect to the sum of the weights of the dry components only of the composition.

10. The process according to claim 9, in which said amount of woody particulate is between 96 and 98% by weight with respect to the sum of the weights of the dry components only of the composition.

11. The process according to claim 1, in which step b) is carried out by mixing or stirring with mechanical means the mixture obtained after joining the components for a period of between a few seconds and a few minutes.

12. Woody particulate coated with modified starch gel obtained according to claim 1.

13. A process for the production of a product made only of the woody particulate coated with modified starch gel according to claim 12, consisting in subjecting said particulate to compression at a pressure between 170 and 280 bar and at a temperature lower than 100° C.

14. The process according to claim 13, in which the particulate is subjected to compression at a pressure between 220 and 250 bar.

15. Product obtained according to the process of claim 13.

16. Composite material obtained by incorporating the particulate of claim 12 into a polymeric material.
